(19) United States
(12) Patent Application Publication
(10) Pub. No.: US 2011/0223823 A1
(43) Pub. Date: Sep. 15, 2011

(54) SUPERHYDROPHILIC WOOL FABRIC WITH WASH FASTNESS AND NANO-FINISHING METHOD FOR PREPARING THE SAME

(76) Inventors: Dong Chen, Beijing (CN); Longfei Tan, Beijing (CN); Fangqiong Tang, Beijing (CN); Huiyu Liu, Beijing (CN); Yi Li, Hong Kong (CN)

(21) Appl. No.: 13/130,056

(22) PCT Filed: Mar. 10, 2010
(86) PCT No.: PCT/CN10/70969

§ 371 Date: May 19, 2011

(30) Foreign Application Priority Data
Mar. 31, 2009 (CN) 200910081298.2

(51) Int. Cl. B32B 5/02; B05D 3/00; B05D 5/00; B05D 7/00; B05D 3/10; B82Y 30/00

(52) U.S. Cl. 442/118; 427/314; 977/773

(57) ABSTRACT

A superhydrophilic wool fabric with wash fastness and a preparation method thereof are disclosed. Nanometer particles are grafted on the fiber surface of the superhydrophilic wool fabric with wash fastness by chemical bonds. The nanometer particles include nanometer silicon dioxide whose particle diameter is 10-800 nm. Based on the total mass of the superhydrophilic wool fabric with wash fastness, the amount of the nanometer silicon dioxide is 0.05-5% by mass. The preparation method of the present application includes the following steps: pretreating a wool fabric with a coupling agent; then adjusting the pH value of the reactive solution, immersing the pretreated wool fabric in the reactive solvent and stirring under constant temperature; adding silicon dioxide particles with a particle diameter of 10-800 nm or a solution that contains precursor of silicon dioxide into the reacting solvent in which the wool fabric is immersed, readjusting pH value of the reactive solution, oscillating for a period of time under constant temperature, taking out the wool fabric, cleaning and drying. The superhydrophilic wool fabric with wash fastness of the present application has the effects of water-absorbing and quick drying, and is fully wash wear. The operation of the method of the present invention is simple. A functionality design can be realized in the microcosmic field. The fabric of the present invention simultaneously has multiple functions such as water- absorbing and quick drying, bacteriostasis, and self-cleaning.

### FIELD OF THE INVENTION

The present invention relates to a wool fabric and a finishing method for the same, in particular to a superhydrophilic wool fabric with wash fastness and a nano-finishing method for preparing the same. The nano-finishing method provided by the present invention is especially suitable for superhydrophilic finishing of high-end wool fabrics.

### BACKGROUND OF THE INVENTION

Fiber hydrophilicity is an important factor for normal functioning of the natural regulation system of human body and comfortability of wear of clothing. Fiber hydrophilicity covers two aspects: hygroscopicity and water absorption of fibers. When the human body sweats out, the fibers absorb vaporous water from the skin on one hand, behaving as the hygroscopicity of fabric; on the other hand, the fibers absorb water in liquid phase from the skin, behaving as the water absorption of fabric. The hygroscopicity and water absorption of fibers are not only related with the chemical structure of the fibers but also related with the physical structure and morphological structure of the fibers, such as pores and cavities in the fabric structure, and specific surface area of fiber surface.

Rabbit wool, sheep wool, and alpaca wool are ideal natural clothing-making materials, owing to their characteristics such as light weight, warmth retention, and soft. These natural wool fabrics have high hygroscopicity but poor water absorption, which is to say, they can't absorb the great deal of sweat produced by the human body in a hot environment or during strenuous exercises and transfer out the sweat timely; as a result, the human body will feel damp, sultry, and uncomfortable. If the microstructure of the wool can be modified to have superhydrophilicity and can transfer out the sweat timely, the comfortability of the wool fabrics will be greatly improved.

To improve the hydrophilicity of fabrics, a low-temperature plasma treatment technique is disclosed in Chinese Patent Application No. 01110561.5 (titled as Super-Amphipathic Textile Fibers and Producing Method and Application Thereof). The technique utilizes the action between plasma and textile surface in an appropriate atmosphere to introduce new groups to the surface of the textile, so as to improve the hydrophilicity of the textile; however, the hydrophilicity of textile treated in a plasma atmosphere can't last long, and the equipment used for the treatment is costly. A method for producing vapor permeable and sweat absorbent fibers or fabrics is disclosed in Chinese Patent Application No. 200410037803.0 (titled as Application of Superhydrophilic and/or Superlipophilic Nanometer Porous Material). In that method, a nanometer porous material such as silicon oxide and/or titanium oxide is coated on the surface of the fibers or fabric. However, in that method, to prepare the nanometer porous material, the pore template agent has to be removed at a high temperature, and the fabric has to be pre-treated through a plasma treatment to increase the polar component on the surface. A method for improving hydrophilicity and comfortability of fabrics by fixing a nanometer functional material to different kinds of porous keratin fabrics through dipping-rolling-baking process is disclosed in Chinese Patent Application No. 200710002393.X (titled as Hydrophiling Nanometer-Level Surface Finishing Method for Porous Keratin Fabrics). That method is simple in process, easy to operate, and low in production cost; however, the treated fabrics have poor hand feeling and poor wash fastness.

### SUMMARY OF THE INVENTION

An object of the present invention is to provide a superhydrophilic wool fabric with wash fastness (i.e., with zero contact angle between the fiber surface of the wool fabric and water), the superhydrophilic wool fabric with wash fastness has nanometer particles grafted by chemical bond on the surface of wool fiber; the nanometer particles comprise nanometer silicon dioxide with a particle diameter of 10-800 nm; based on the total mass of the wool fabric, the content of the nanometer silicon dioxide is 0.05-5% by mass. Preferably, the particle diameter of the nanometer silicon dioxide particles is 10-400 nm.

Another object of the present invention is to provide a multi-functional superhydrophilic wool fabric with wash fastness. The surface of the multi-functional superhydrophilic wool fabric with wash fastness has nanometer particles grafted by chemical bond. The nanometer particles comprise nanometer silicon dioxide particles with a particle diameter of 10-800 nm and functional nanometer particles; the functional nanometer particles are at least one selected from the group consisting of nanometer gold with a particle diameter of 1-100 nm, nanometer silver with a particle diameter of 1-100 nm, nanometer copper with a particle diameter of 1-100 nm, nanometer titanium oxide with a particle diameter of 5-500 nm, and nanometer zinc oxide with a particle diameter of 5-500 nm. Based on the total mass of the wool fabric, the content of the nanometer silicon dioxide is 0.05-5% by mass, and the content of the functional nanometer particles is 0.05-5% by mass.

Another object of the present invention is to provide a nano-finishing method for producing the superhydrophilic wool fabric with wash fastness, to add water-absorbing and quick-drying characteristics to the fabric.

Another obj ect of the present invention is to provide a nano-finishing method for producing the multi-functional superhydrophilic wool fabric with wash fastness.

The nano-finishing method for producing a superhydrophilic wool fabric with wash fastness provided by the present invention comprises:

first, pre-treating the wool fabric with a coupling agent;

then, adding silicon dioxide particles with a particle diameter of 10-800 nm to the reacting solvent, immersing the wool fabric treated by step (1) into the reacting solvent, adjusting the pH value of the reacting solution, oscillating the solution at a constant temperature for a period of time, taking out the wool fabric, after rinsing the wool fabric, drying the wool fabric; or

adjusting the pH value of the reacting solvent, immersing the pre-treated wool fabric into the reacting solvent, agitating at a constant temperature for a period of time, adding a solution that contains an appropriate amount of precursor of silicon dioxide into the reacting solvent where the wool fabric is immersed, adjusting the pH value of the reacting solution, oscillating at a constant temperature for a period of time, taking out the wool fabric, after rinsing the wool fabric, drying the wool fabric.

The nano-finishing method for producing the superhydrophilic wool fabric with wash fastness provided by the present invention, comprising the following steps:

(1) rinsing and drying the wool fabric to be treated, immersing the wool fabric into a solution that contains coupling agent at a concentration of 2-2000 mmol/L and keeping for 2 min-10 h, taking out the wool fabric, and drying it naturally or at 40-100° C..;

(2) adding silicon dioxide particles with a particle diameter of 10-800 nm into a reacting solvent to make the mass fraction of the silicon dioxide particles in the reacting solvent be 0.1-10%, immersing the wool fabric treated by step (1) into the reacting solvent and keeping the bath ratio at 1:5-1:100, adjusting the pH value of the reacting solution to 1-7 by an acid, and then oscillating at a constant temperature within a range of 40-100° C..; or

adjusting the pH value of the reacting solvent with an inorganic base to 8-14, immersing the wool fabric treated by step (1) into the reacting solvent and keeping the bath ratio at 1:5-1:100; agitating; adding a solution that contains a precursor of silicon dioxide and controlling the content of the precursor of silicon dioxide in the reacting solvent at a mass fraction of 0.1-10%, and agitating at a constant temperature within a range of 30-100° C..; adjusting the pH value of the reacting solution to 1-7 by an acid, and then oscillating at a constant temperature within a range of 40-100° C..;

(3) taking out the wool fabric treated by step (2), and rinsing and drying it, to obtain a superhydrophilic wool fabric with wash fastness.

The reacting solvent is at least one selected from the group consisting of water, methanol, ethanol, propanol, butanol, toluene, tetrachloroethylene, methylene chloride, N,N-dimethyl formamide and dimethyl sulfoxide.

The superhydrophilic wool fabric with wash fastness obtained by the above nano-finishing method has nanometer particles grafted by chemical bonds on the wool surface; the nanometer particles comprise silicon dioxide particles with a particle diameter of 10-800 nm and/or nanometer silicon dioxide particles with a particle diameter of 10-800 nm obtained by hydrolization of the precursor of silicon dioxide.

The nano-finishing method for producing the superhydrophilic wool fabric with wash fastness provided by the present invention may further comprise the following steps:

adding functional nanometer particles, before or after adding silicon dioxide particles with a particle diameter of 10-800 nm and before adjusting the pH value of the reacting solution with an acid to 1-7 and before oscillating at a constant temperature within a range of 40-100° C..; or

adjusting the pH value of the reacting solvent with an inorganic base to 8-14, and adding solid powder of a precursor of the functional nanometer particles into the reacting solvent or adding a solution that contains a precursor of the functional nanometer particles, and agitating at a constant temperature within a range of 30-100° C.., before or after adding the silicon dioxide particles with a particle diameter of 10-800 nm and before adjusting the pH value of the reacting solution with an acid to 1-7 and oscillating at a constant temperature within a range of 40-100° C.; or

adding functional nanometer particles to the reacting solvent, or adding solid powder of a precursor of the functional nanometer particles to the reacting solvent, or adding a solution that contains a precursor of the functional nanometer particles to the reacting solvent, before or after adding the solution that contains a precursor of silicon dioxide and before agitating at a constant temperature within a range of 30-100° C., and after immersing the wool fabric treated by step (1) into the reacting solvent adjusted the pH value with an inorganic base to 8-14; then, agitating at a constant temperature within a range of 30-100° C., and performing subsequent steps after the agitation at a constant temperature within a range of 30-100° C.

Wherein, the mass fraction of the functional nanometer particles or the precursor of the functional nanometer particles added into the reacting solvent is 0.1-10% in the reacting solvent.

The multi-functional superhydrophilic wool fabric with wash fastness obtained in that way has nanometer particles grafted by chemical bonds on the wool surface; the nanometer particles comprise silicon dioxide particles with a particle diameter of 10-800 nm and/or nanometer silicon dioxide particles with a particle diameter of 10-800 nm obtained by hydrolization of the precursor of silicon dioxide, and the functional nanometer particles and/or functional nanometer particles obtained by hydrolization of the precursor of functional nanometer particles.

The superhydrophilic refers to that the contact angle between the fiber surface of wool fabric and water is zero.

The bath ratio refers to the mass ratio of the wool fabric to the reacting solvent.

The mass fraction refers to the mass ratio of the silicon dioxide particles with a particle diameter of 10-800 nm, precursor of silicon dioxide, functional nanometer particles, or precursor of functional nanometer particles to the reacting solvent with a pH value of 8-10.

The functional nanometer particles is at least one selected from the group consisting of nanometer gold with a particle diameter of 1-100 nm, nanometer silver with a particle diameter of 1-100 nm, nanometer copper with a particle diameter of 1-100 nm, nanometer titanium oxide with a particle diameter of 5-1,000 nm, and nanometer zinc oxide with a particle diameter of 5-1,000 nm. Preferably, the particle diameter of the nanometer titanium oxide is 5-500 nm, and the particle diameter of the nanometer zinc oxide is 5-500 nm.

The solution that contains the precursor of functional nanometer particles is obtained by dissolving solid powder of the precursor of functional nanometer particles into the solvent, wherein, the solvent is at least one selected from the group consisting of water, methanol, ethanol, propanol, isopropanol, and butanol. The present invention has no special restriction to the concentration of the solution that contains the precursor of functional nanometer particles, as long as the concentration and amount of the solution can ensure the mass fraction of the precursor of functional nanometer particles is within the range of 0.1-10% in the reacting solvent.

The solid powder of the precursor of functional nanometer particles is at least one selected from the group consisting of precursor of nanometer gold with a particle diameter of 1-100 nm, precursor of nanometer silver with a particle diameter of 1-100 nm, precursor of nanometer copper with a particle diameter of 1-100 nm, precursor of nanometer titanium oxide with a particle diameter of 5-1,000 nm or 5-500 nm, and precursor of nanometer zinc oxide with a particle diameter of 5-1,000 nm or 5-500 nm.

Accordingly, the obtained particles are at least one selected from the group consisting of nanometer gold with a particle diameter of 1-100 nm, nanometer silver with a particle diameter of 1-100 nm, nanometer copper with a particle diameter of 1-100 nm, titanium oxide with a particle diameter of 5-1000 nm, and nanometer zinc oxide with a particle diameter of 5-1000 nm. Preferably, the nanometer titanium oxide obtained by hydrolization of the precursor of functional nanometer particles is nanometer titanium oxide with a particle diameter of 5-500 nm, and the nanometer zinc oxide obtained by hydrolization of the precursor of functional nanometer particles is nanometer zinc oxide with a particle diameter of 5-500 nm.

The precursor of nanometer gold is chloroauric acid.

The precursor of nanometer silver is silver nitrate.

The precursor of nanometer copper is selected from one of cupric chloride, cuprous chloride, cupric sulfate, cuprous sulfate, cupric nitrate, and cuprous nitride.

The precursor of nanometer titanium oxide is selected from one of tetrabutyl titanate, isopropyl titanate, titanium tetrachloride, and titanium tetrafluoride.

The precursor of nanometer zinc oxide is selected from one of zinc chloride, zinc sulfate, zinc nitrate, and zinc acetate.

The time of natural drying described in step (1) is 30 min-10 h; the time of the drying performed at a temperature of 40-100° C. is 5-300 min.

In step (2), the time of agitation performed at a constant temperature within the range of 30-100° C. is 2-300 min; the time of oscillation performed at a constant temperature within the range of 40-100° C. is 20-200 min.; there is no special restriction to the time of agitation in step (2), as long as the agitation ensures the wool fabric is evenly dispersed in the reacting solvent; usually, the agitation time may be 2-30 min.

The present invention has no special restriction to the rinsing and drying method for the wool fabric to be treated in step (1), which is to say, the method may be any method well-known by those skilled in the art. In addition, there is no special restriction to the amount of the solution that contains coupling agent used for immersing the wool fabric, as long as the amount of the solution that contains coupling agent is enough to ensure the wool fabric is completed immersed and the content of coupling agent in the solution that contains coupling agent meets the requirement. On the premise that the silicon dioxide particles and the functional nanometer particles may be grafted to the surface of the wool fabric, the amount of the solution that contains coupling agent may be 5-50 L for 1 kg wool fabric.

The rinsing described in step (3) may be performed with any method known by those skilled in the art; preferably, the rinsing is performed with tap water; the present invention has no special restriction to the drying described in step (3), which is to say, the drying may be performed with any common method in the field.

The solvent used for preparing the solution that contains coupling agent is at least one selected from the group consisting of methanol, ethanol, propanol, butanol, amyl alcohol, toluene, tetrachloroethylene, methylene chloride, N,N-dimethyl formamide and dimethyl sulfoxide.

The coupling agent may be at least one selected from the group consisting of silane coupling agent with epoxy group, silane coupling agent with amino group, silane coupling agent with vinyl group, silane coupling agent with alkyl group, and coupling agent based on titanate.

The silane coupling agent with epoxy group is γ-glycidoxypropyltrimethoxysilane, γ-glycidoxypropyltriethoxysilicane, or their mixture.

The silane coupling agent with amino group is at least one selected from the group consisting of γ-aminopropyl trimethoxysilane, γ-aminopropyl triethoxysilane, bis[3-(triethoxysilye propyl]amine, γ-aminopropyl methyl dimethoxysilane, N-methyl-γ-aminopropyl trimethoxysilane, and N-methyl-γ-aminopropyl triethoxysilane.

The silane coupling agent with vinyl group is at least one selected from the group consisting of vinyltrimethoxysilane, vinylmethyldimethoxysilane, vinyltriethoxysilane, and vinylmethyldiethoxysilane.

The silane coupling agent with alkyl group is at least one selected from the group consisting of methyltrimethoxysilane, methyltriethoxysilane, propyltrimethoxysilane, and propyltriethoxysilicane.

The coupling agent based on titanate is at least one selected from the group consisting of isopropyl triisophthaloyl titanate, isopropyl dodecylbenzenesulfonyl titanate, isopropyl tri(dioctyl pyrophosphate) titanate, tetraisopropyl bis(dioctyl phosphite) titanate, tetraoctyl bis[di(dodecyl) phosphite] titanate, tetra(2,2-diallyloxy-methyl-1-butyl) bis[di(tridecyl) phosphite] titanate, bis(dioctyl pyrophosphate)oxyacetate titanate, and bis(dioctyl pyrophosphate)ethylene titanate.

The inorganic base is at least one selected from the group consisting of lithium hydroxide, sodium hydroxide, potassium hydroxide, and ammonia.

The precursor of silicon dioxide is at least one selected from the group consisting of sodium silicate, tetramethyl orthosilicate, tetraethyl orthosilicate, tetrapropyl orthosilicate, and tetrabutyl orthosilicate.

The solvent for preparing the solution that contains the precursor of silicon dioxide may be at least one selected from the group consisting of water, methanol, ethanol, propanol, isopropanol, and butanol.

The present invention has no special restriction to the concentration of the solution that contains the precursor of silicon dioxide, as long as the concentration and amount of the solution ensure the mass fraction of the precursor of silicon dioxide in the reacting solvent is within the range of 0.1-10%. Usually, the concentration of the solution that contains the precursor of silicon dioxide may be 0.5-5 mol/L.

The acid described in step (2) may be at least one selected from the group consisting of hydrochloric acid, formic acid, oxalic acid, acetic acid, nitric acid, phosphoric acid, and sulfuric acid; preferably, the acid is hydrochloric acid, oxalic acid, or acetic acid.

The present invention has no special restriction to the concentration and use of the acid in step (2). The acid may be at any concentration suitable for adjusting the pH value of the solution and may be used with any method well-known to those skilled in the art.

The wool fabric comprises rabbit wool fabric, sheep wool fabric, cashmere fabric, alpaca wool fabric, or blend fabric produced from these fabrics at any blend ratio.

The wool fabric according to the present invention has superhydrophilicity (with zero contact angle between the fiber surface of wool fabric and water). Since water drops can diffuse quickly in the wool fabric, the comfortability of wear and functionality of the wool fabric are greatly improved; in addition, the wool fabric is quite resistant to washing. A multi-functional wool fabric can be obtained, by adding a solution that contains other functional nanometer particles or the precursors of other functional nanometer particles in the finishing process.

In principle, the method provided by the present invention is to select an appropriate coupling agent, and graft a layer of nanometer silicon dioxide with a particle diameter of 10-800 nm obtained by nanometer silicon dioxide particles or a precursor of silicon dioxide on the fiber surface of the wool fabric by chemical bonds, so as to from a nanometer-level unevenness structure on the micron-level fiber surface, and thereby increase the roughness of fiber surface and further improve the hydrophilicity of the hydrophilic silicon dioxide rich in hydroxyl, to obtain a superhydrophilic wool fabric. As a result, the diffusion rate and range of water in liquid phase on the surface of the superhydrophilic wool fabric provided by the present invention are greatly increased, and thereby the effects of water absorption, sweat absorption, and quick-drying are attained. The chemical bonds formed between the nanometer silicon dioxide particles on the wool surface and the fibers enhance the bonding force between the fibers and the nanometer silicon dioxide particles, and thereby enhance the wash fastness of the wool fabric. In addition, a multi-functional wool fabric can be obtained by adding a solution that contains other functional nanometer particles or the precursors of other functional nanometer particles; moreover, the uniform and dense nanometer silicon dioxide layer formed on the surface of the wool fabric can increase the bonding force between the wool fabric and other functional particles, so that the wash fastness of the wool fabric is improved.

Apparent differences between the method provided by the present invention and the existing methods in the prior art include: in the method provided by the present invention, the preparation of the superhydrophilic nanometer silicon dioxide particles is performed simultaneously with the surface functionalization of the wool fabric; in addition, other functions, such as antibacterial and self-cleaning functions, may be added to the wool fabric, while superhydrophilicity is bestowed to the wool fabric. Therefore, the production process is simplified, the energy consumption and cost are reduced, and the method is suitable for mass production of wool fabric. The method provided by the present invention is easy to use, can implement functional design of fabrics at microscopic level, and incorporates water-absorbing, quick-drying, anti-bacterial, and self-cleaning functions, etc.

### BRIEF DESCRIPTION OF THE DRAWINGS

FIG. 1 is an X-ray energy spectrogram of the superhydrophilic sheep wool cloth with wash fastness according to Example 1 of the present invention.

FIG. 2 is an X-ray photoelectron energy spectrogram of the untreated sheep wool cloth used in Example 1 of the present invention.

FIG. 3 is an X-ray photoelectron energy spectrogram of sheep wool cloth treated with coupling agent according to Example 1 of the present invention.

FIG. 4 is an X-ray photoelectron energy spectrogram of the superhydrophilic sheep wool cloth with wash fastness according to Example 1 of the present invention.

FIG. 5 is a Fourier transform infrared spectrogram, wherein, curve a shows the case of untreated sheep wool cloth, curve b shows the case of sheep wool cloth treated with coupling agent, curve c shows the case of superhydrophilic sheep wool with wash fastness according to Example 1 of the present invention.

FIG. 6 is a structural diagram of the wool fibers in the untreated sheep wool cloth used in Example 1 of the present invention.

FIG. 7 is a structural diagram of the wool fibers in the superhydrophilic sheep wool cloth with wash fastness in Example 1 of the present invention.

FIG. 8 is a photograph of the static contact angle on the untreated sheep wool cloth used in the Example 1 of the present invention.

FIG. 9 is a photograph of the static contact angle on the superhydrophilic sheep wool cloth with wash fastness according to Example 1 of the present invention.

FIG. 10 shows the water absorption situation of the superhydrophilic sheep wool cloth with wash fastness according to Example 1 of the present invention after machine washing for different times.

FIG. 11 is a structural diagram of the fibers in the superhydrophilic sheep wool cloth with wash fastness according to Example 1 of the present invention after machine washing for 20 times.

FIG. 12 shows the water absorption situation of the sheep wool cloth according to Comparative Example 1 after machine washing for different times.

FIG. 13 is an anti-bacterial effect diagram of the superhydrophilic and anti-bacterial sheep wool cloth according to Example 3 of the present invention.

FIG. 14 is a comparison diagram of stains degradation between the superhydrophilic and self-cleaning wool cloth according to Example 5 of the present invention and untreated wool cloth, wherein, the photographs on the left side are photographs of untreated wool cloth before and after exposure to light irradiation, the photographs on the right side are photographs of the superhydrophilic and self-cleaning wool cloth according to Example 5 of the present invention before and after exposure to light irradiation.

### DETAILED DESCRIPTION OF THE EMBODIMENTS

Hereinafter, the present invention will be detailed in Examples, with reference to the accompanying drawings. The Examples are provided here only for describing the technical scheme of the present invention, but should not be deemed as constituting any limitation to the protected domain of the present invention.

In the following Examples, the X-ray photoelectron spectrograms are obtained on a MKII X-ray photoelectron spectrograph from VG Company (UK), under Al Ka X-Ray (1486.6 eV).

The Fourier transform infrared spectrograms are obtained on a FTIR-1730 Fourier transform infrared spectrometer, in attenuated total reflection mode.

The total content of nanometer silicon dioxide particles and functional nanometer particles grafted on the fiber surface of wool fabric is obtained by calculating the mass change before and after treatment of the wool fabric, and the mass ratio between nanometer silicon dioxide particles and functional nanometer particles is calculated from the content ratios of elements obtained in the X-ray energy spectrum test, so as to obtain the content of nanometer silicon dioxide particles and the content of functional nanometer particles on the fiber surface of the wool fabric, respectively.

The X-ray energy spectrum analysis and scanning electron microscope (SEM) analysis are performed on a Hitachi S-4300 cold-field emission scan electronic microscope, at 15 kV and 10 kV operating voltages, respectively. The surface of sample is sprayed with gold to increase electrical conductivity of the sample.

The static contact angle with water drops is measured on a Phoenix-300 surface tension analyzer, at a temperature of 20° C.±2° C. and a relative humidity of 65%±2%.

The wash fastness is evaluated by testing the water absorption times of wool cloth after machine washing for different times. The machine washing method is: with reference to the AATCC Test Method No. 135-2004, use a Haier household washing machine with 20 L capacity, add the AATCC Standard Reference Detergent in appropriate amount, and wash for 8 min at a water temperature of 40° C.

The water absorption time is tested with the method specified in British Standard 4554:1970, and the water absorption time of each sample group is the average of three test results. According to the standard, fabrics with water absorption time longer than 200 s are regarded as non-infiltrated fabrics. Therefore, the water absorption time of any sample with a water absorption time longer than 200 s in the test is recorded as 200 s.

The anti-bacteria test is performed according to the method specified in Chinese Standard GB/T20944.1-2007.

The self-cleaning performance testing method is: drop 0.1 mL 10⁻⁵ M ethanol solution of Rhodamine B on the wool cloth, and keep the wool cloth exposed to the irradiation of a 40 W ultraviolet lamp for 1 h.

### Example 1

(1) Rinse and dry the sheep wool cloth to be treated, and weigh 100 g sheep wool cloth, immerse the wool cloth into 1 L methanol solution that contains 2 M γ-aminopropyltriethoxysilane, hold for 2 min, and then take out the wool cloth and dry 5 min at 100° C.;

(2) Immerse the wool cloth treated by step (1) in water with pH adjusted to 8 by ammonia, at a bath ratio of 1:80, and agitate for 5 min at room temperature; then, add ethanol solution of tetraethyl orthosilicate at a concentration of 4 mol/L, and control the mass fraction of tetraethyl orthosilicate in the water with pH=8 at 10%, and agitate for 10 min at a constant temperature of 80° C.; adjust the pH value the reacting solution with hydrochloric acid to 4, and then oscillate for 20 min at a constant temperature of 70° C.;

(3) Take out the wool cloth treated by step (2), rinse it with tap water for three times, and dry it, to obtain a superhydrophilic wool cloth with wash fastness.

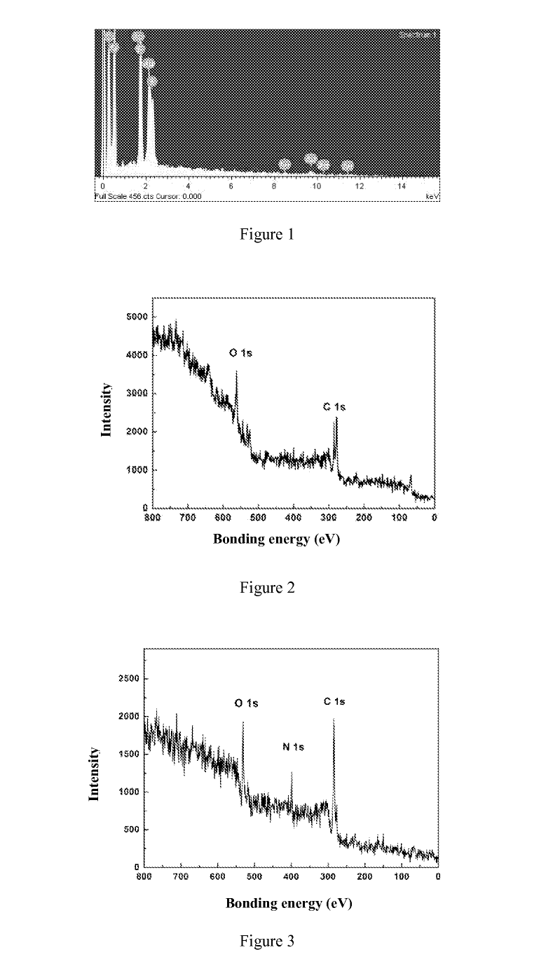

FIG. 1 is an X-ray energy spectrogram of the obtained superhydrophilic sheep wool cloth with wash fastness. It is seen from FIG. 1 that silicon element exists on the surface of the superhydrophilic wool cloth with wash fastness of the present invention, wherein, the gold element that appears in the spectrogram comes from the gold layer coated on the surface of the sample.

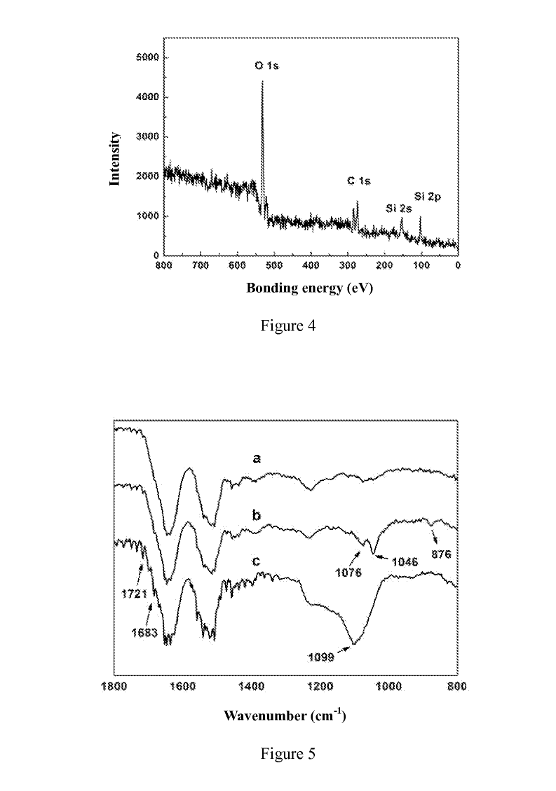

FIGS. 2-4 show photoelectron energy spectrograms of untreated wool cloth, wool cloth treated with coupling agent, and the obtained superhydrophilic wool cloth with wash fastness. By comparing FIG. 3 and FIG. 4, with FIG. 2, it can be seen that after the wool cloth is treated with a coupling agent (i.e., γ-aminopropyltriethoxysilane), the characteristic peak of element N on the surface of the wool cloth appears, indicating the surface of the wool cloth has grafted coupling agent; then, after silicon dioxide is grafted chemically, the characteristic peak of element N on the surface of the wool cloth disappears, while the characteristic peak of element Si appears instead, indicating silicon dioxide is grafted successfully onto the fiber surface of the wool cloth.

FIG. 5 is a Fourier transform infrared spectrogram. As indicated by the curve b in FIG. 5, after the wool cloth is treated with a coupling agent, the peaks that appear at 1046 cm⁻¹ and 1076 cm⁻¹ correspond to linear polysiloxane; the new peak that appears at 876 cm⁻¹ is the stretching vibration peak of Si—N, and indicates that the coupling agent is grafted to the fiber surface of the wool cloth by chemical bonds; as indicated by the curve c in FIG. 5, after nanometer silicon dioxide particles are grafted further to the fiber surface of the wool cloth, the peaks that appear at 1721 cm⁻¹ and 1683 cm⁻¹ corresponds to the stretching vibration peak of C═O, resulted from the new ester bonds and amido bonds; the broad peak that appears at 1099 cm⁻¹ is the characteristic peak of Si—O—Si, and indicates new silicon dioxide particles are grafted to the fiber surface of the wool cloth.

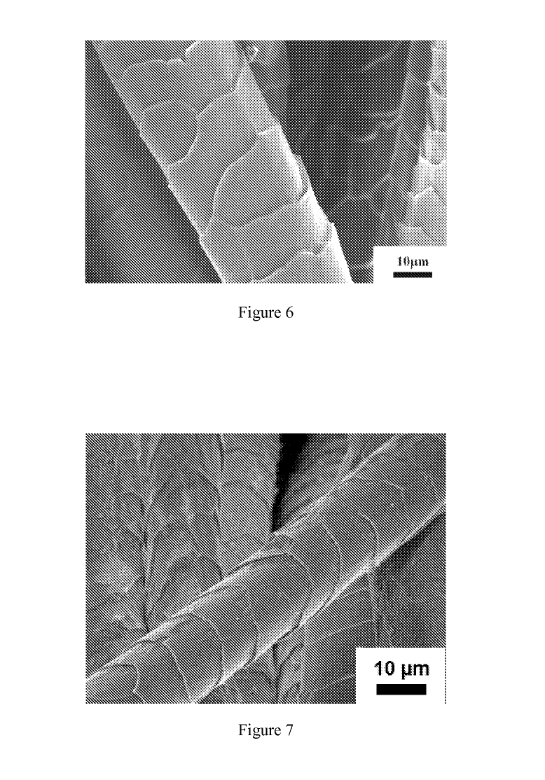

FIG. 6 and FIG. 7 show structural diagrams of the wool fibers of untreated wool cloth and the wool fibers of the superhydrophilic wool cloth with wash fastness of the present invention, obtained on a SEM. The SEM analysis indicates that the superhydrophilic wool cloth with wash fastness of the present invention has a layer of nanometer silicon dioxide with a particle diameter of about 30 nm obtained from hydrolization of tetraethyl orthosilicate and grafted to the fiber surface of the wool cloth by chemical bonds. 105 g wool cloth grafted with nanometer silicon dioxide is obtained. Based on the total mass of the wool cloth, the content of the nanometer silicon dioxide is about 5% by mass.

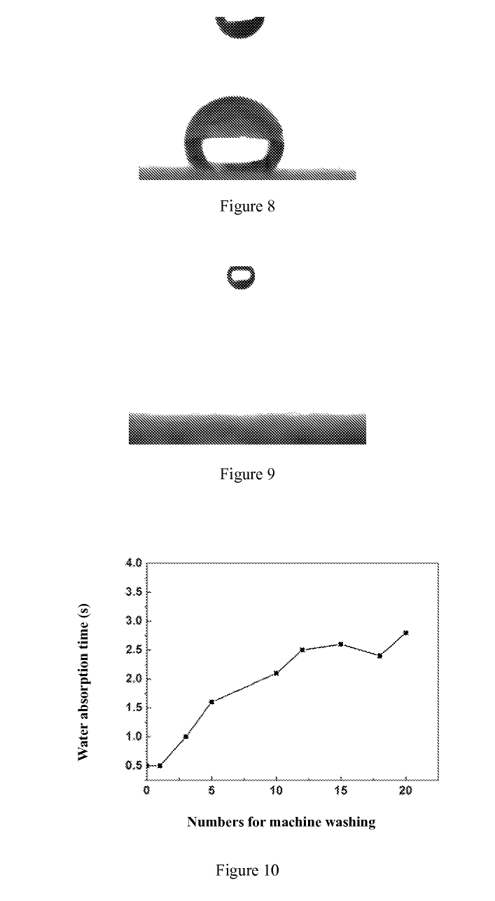

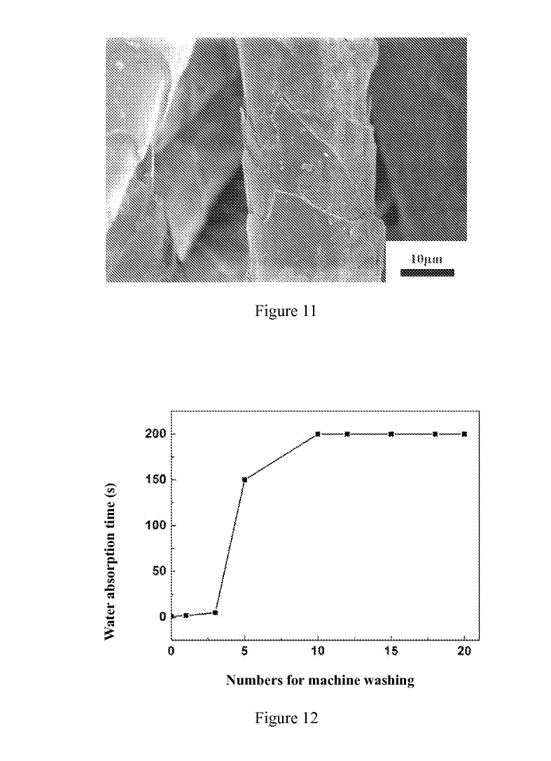

The hydrophilicity of the wool cloth can be evaluated by measuring the static contact angle with water drops. FIG. 8 and FIG. 9 show photographs of the static contact angle between untreated wool cloth and water drops and the static contact angle between the superhydrophilic wool cloth with wash fastness of the present invention and water drops, wherein, the static contact angle between untreated wool cloth and water drops is 112 degree, while the static contact angle between the superhydrophilic wool cloth with wash fastness of the present invention and water drops is zero. FIG. 10 shows the wash fastness of the superhydrophilic wool cloth with wash fastness of the present invention. As shown in FIG. 10, the water absorption time after machine washing for 20 times is 2.8 s, which indicates that the water absorption rate is high. The structural diagram of wool fibers of the superhydrophilic wool cloth with wash fastness according to the present invention obtained by SEM analysis after machine washing for 20 times is shown in FIG. 11. It is seen from FIG. 11 that the wool fiber surface still has a large quantity of nanometer silicon dioxide particles after machine washing for 20 times, and therefore the superhydrophilicity of the wool cloth is remained.

### Comparative Example 1

Treat the wool cloth with the same method as described in Example 1, but don't treat the wool cloth with the coupling agent as described in step (1). Test the wash fastness of the obtained wool cloth with the same method as described in Example 1. The result is shown in FIG. 12. The result indicates that the water absorption time of the superhydrophilic wool cloth that is not treated with a coupling agent is longer than 200 s after machine washing for 10 times, indicating the wool cloth is not hydrophilic any more.

### Example 2

(1) Rinse and dry the cashmere cloth to be treated, and weigh 200 g cashmere cloth, immerse the cashmere cloth into 1 L toluene solution that contains 2 mM γ-aminopropyltrimethoxysilane, hold for 10 h, and then take out the cashmere cloth and dry for 300 min at 40° C.;

(2) Immerse the cashmere cloth treated by step (1) in a mixed solution of water and ethanol (mixed at a volume ratio of 1:1) with pH adjusted to 14 by potassium hydroxide, at a bath ratio of 1:100; agitate for 10 min at room temperature; then, add methanol solution of tetramethyl orthosilicate at a concentration of 5 mol/L, and control the mass fraction of the tetramethyl orthosilicate in the mixed solution of water and ethanol with pH=14 at 0.1%, and agitate for 300 min at a constant temperature of 60° C.; adjust the pH value of the reacting solution with hydrochloric acid to 1, and then oscillate for 60 min at a constant temperature of 100° C.;

(3) Take out the cashmere cloth treated by step (2), rinse it with tap water for three times, and dry it, to obtain a superhydrophilic cashmere cloth with wash fastness.

The result of static contact angle test indicates that the contact angle between the surface of cashmere cloth and water is zero. The result of SEM analysis indicates that the fiber surface of the treated cashmere cloth has a layer of nanometer silicon dioxide with a particle diameter of 700-800 nm obtained from hydrolization of tetramethyl orthosilicate and grafted to the fiber surface by chemical bonds. 202 g cashmere cloth grafted with nanometer silicon dioxide is obtained. Based on the total mass of the cashmere cloth, the content of silicon dioxide is about 1.0% by mass.

### Example 3

(1) Rinse and dry the sheep wool cloth to be treated, and weigh 100 g sheep wool cloth, immerse the wool cloth into 1 L tetrachloroethylene solution that contains 200 mM γ-glycidoxypropyltrimethoxysilane, hold for 30 min., and then take out the wool cloth and dry for 20 min at 60° C.;

(2) Immerse the wool cloth treated by step (1) in water solution of sodium hydroxide and ammonia (at a molar ratio of 1:1) with pH=10, at a bath ratio of 1:50; agitate for 15 min at room temperature; then, add water solution of sodium silicate at a concentration of 1 mol/L, wherein, the mass fraction of sodium silicate in the water solution of sodium hydroxide and ammonia with pH=10 is 1%; then, add nanometer silver particles with a particle diameter of 60 nm into the solution, wherein, the mass fraction of the nanometer silver particles in the water solution of sodium hydroxide and ammonia with pH=10 is 0.2%; agitate for 2 min at a constant temperature of 80° C., adjust the pH value of the reacting solution with acetic acid to 3, and then oscillate for 30 min at a constant temperature of 80° C.;

(3) Take out the wool cloth treated by step (2), rinse it with tap water for three times, and dry it, to obtain a multi-functional superhydrophilic wool cloth with wash fastness.

The result of static contact angle test indicates that the contact angle between the surface of wool cloth and water is zero. The result of SEM analysis indicates that the fiber surface of the treated wool cloth has a particle layer composed of nanometer silicon dioxide with a particle diameter of 10-20 nm obtained from hydrolization of sodium silicate and nanometer silver particles with a particle diameter of 60 nm, and grafted by chemical bonds. 100.9 g wool cloth grafted with nanometer silicon dioxide is obtained; the mass ratio between silicon and silver obtained by X-ray energy spectrum test is 3.73:1. Based on the total mass of the wool cloth, the content of nanometer silicon dioxide is about 0.7% by mass, and the content of the nanometer silver particles is about 0.2% by mass.

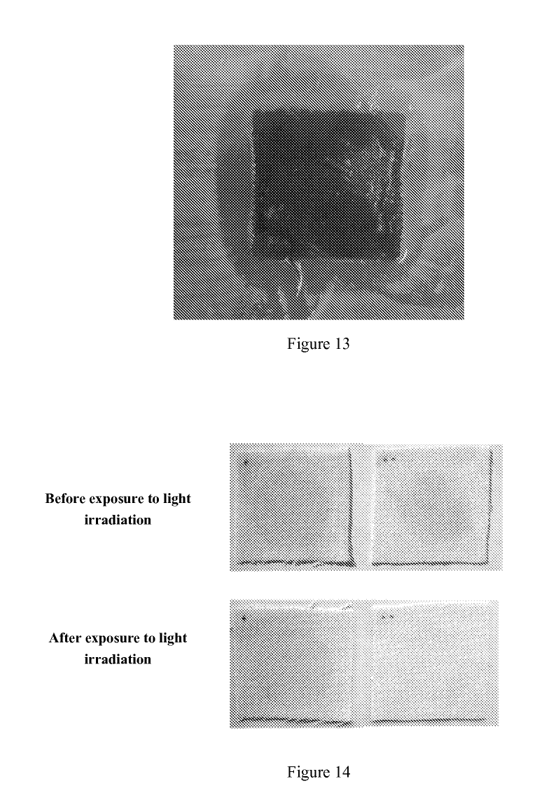

Perform anti-bacteria test for the multi-functional superhydrophilic wool cloth. The result is shown in FIG. 13. It is seen that the anti-bacteria zone is wider than 2 mm; therefore, the multi-functional superhydrophilic wool cloth has high anti-bacterial performance.

### Example 4

(1) Rinse and dry the sheep wool cloth to be treated, and weigh 200 g sheep wool cloth, immerse the wool cloth into 1 L mixed methylene chloride and tetrachloroethylene solution (at a volume ratio of 1:3) that contains 50 mM vinyltriethoxysilane, hold for 20 min., and then take out the wool cloth and dry for 10 min at 100° C.;

(2) Immerse the wool cloth treated by step (1) in butanol with pH adjusted to 10 by potassium hydroxide and ammonia (at a molar ratio of 1:1), at a bath ratio of 1:5; agitate for 20 min at room temperature; then, add butanol solution of tetrabutyl orthosilicate at a concentration of 3 mol/L and butanol solution of tetrabutyl titanate at a concentration of 0.5 mol/L in sequence, and control the mass fraction of tetrabutyl orthosilicate in the butanol solution with pH=10 at 5% and the mass fraction of tetrabutyl titanate in the butanol solution with pH=10 at 5%, and agitate for 30 min at a constant temperature of 80° C.; adjust the pH value of the reacting solution with oxalic acid to 4, and then oscillate for 30 min at a constant temperature of 80° C.;

(3) Take out the wool cloth treated by step (2), rinse it with tap water for three times, and dry it, to obtain a multi-functional superhydrophilic wool cloth with wash fastness.

The result of static contact angle test indicates that the contact angle between the surface of wool cloth and water is zero. The result of SEM analysis indicates that the fiber surface of the treated wool cloth has a particle layer composed of nanometer silicon dioxide with a particle diameter of about 200 nm obtained from hydrolization of tetrabutyl orthosilicate and nanometer particles with a particle diameter of about 300 nm obtained from hydrolization of tetrabutyl titanate, and grafted by chemical bonds. 201.5 g wool cloth grafted with nanometer silicon dioxide is obtained; the mass ratio between silicon and titanium obtained in X-ray energy spectrum test is 1.55:1. Based on the total mass of the wool cloth, the content of nanometer silicon dioxide is about 0.5% by mass, and the content of the nanometer titanium oxide particles is about 0.3% by mass.

### Example 5

(1) Rinse and dry the sheep cloth to be treated, and weigh 100 g sheep wool cloth, immerse the wool cloth into 5 L ethanol solution that contains 2 mM vinyltrimethoxysilane, hold for 2 h, and then take out the wool cloth and dry for 20 min at 100° C.;

(2) Immerse the wool cloth treated by step (1) in ammonia water solution with pH=9, at a bath ratio of 1:60, and agitate for 25 min at room temperature; then, add ethanol solution of tetraethyl orthosilicate at a concentration of 4 mol/L and nanometer titanium oxide particle with a particle diameter of 20 nm in sequence, and control the mass fraction of tetraethyl orthosilicate in the ammonia water solution with pH=9 at 5% and the mass fraction of nanometer titanium oxide particles in the ammonia water solution at 0.1%, and agitate for 20 min at a constant temperature of 80° C.; adjust the pH value of the reacting solution with acetic acid to 7, and then agitate for 2 min, and oscillate for 200 min at a constant temperature of 40° C.;

(3) Take out the wool cloth treated by step (2), rinse it with tap water for three times, and dry it, to obtain a multi-functional superhydrophilic wool cloth with wash fastness.

The result of static contact angle test indicates that the contact angle between the surface of wool cloth and water is zero. The result of SEM analysis indicates that the fiber surface of the treated wool cloth has a particle layer composed of nanometer silicon dioxide with a particle diameter of about 50 nm obtained from hydrolization of tetraethyl orthosilicate and nanometer titanium oxide particles with a particle diameter of 20 nm, and grafted by chemical bonds. 101 g wool cloth grafted with nanometer silicon dioxide is obtained; the mass ratio between silicon and titanium obtained by X-ray energy spectrum test is 16.3:1. Based on the total mass of the wool cloth, the content of nanometer silicon dioxide is about 0.9% by mass, and the content of the nanometer titanium oxide particles is about 0.06% by mass.

The obtained multi-functional superhydrophilic wool cloth with wash fastness has a self-cleaning feature. As shown in FIG. 14, after exposure to UV-irradiation for 1 h, the dye stains on the surface of the untreated wool cloth have no change, while almost all of the dye stains on the surface of the multi-functional superhydrophilic wool cloth with wash fastness treated with the method of the present invention are degraded completely.

### Example 6

(1) Rinse and dry the alpaca wool cloth to be treated, and weigh 200 g alpaca wool cloth, immerse the alpaca wool cloth into 1 L dimethyl sulfoxide solution that contains 100 mM γ-glycidoxypropyltriethoxysilicane, hold for 10 h, and then take out the alpaca wool cloth and dry for 3 h at 80° C.;

(2) Immerse the alpaca wool cloth treated by step (1) in ethanol with pH=12 adjusted by ammonia, at a bath ratio of 1:30, and agitate for 5 min at room temperature; then, add methanol solution of tetramethyl orthosilicate at a concentration of 5 mol/L, and control the mass fraction of tetramethyl orthosilicate in the ethanol with pH=12 at 10%, and agitate for 300 min at a constant temperature of 30° C.; adjust the pH value of the reacting solution with phosphoric acid to 3, and then oscillate for 100 min at a constant temperature of 100° C.;

(3) Take out the alpaca wool cloth treated by step (2), rinse it with tap water for three times, and dry it, to obtain a superhydrophilic alpaca wool cloth with wash fastness.

The result of static contact angle test indicates that the contact angle between the surface of alpaca wool cloth and water is zero. The result of SEM analysis indicates that the fiber surface of the treated alpaca wool cloth has a layer of nanometer silicon dioxide with a particle diameter of about 250 nm obtained from hydrolization of tetramethyl orthosilicate and grafted to the fiber surface by chemical bonds. 200.4 g alpaca wool cloth grafted with nanometer silicon dioxide is obtained. Based on the total mass of the alpaca wool cloth, the content of silicon dioxide is about 0.2% by mass.

### Example 7

(1) Rinse and dry the rabbit wool cloth to be treated, and weigh 1 kg rabbit wool cloth, immerse the rabbit wool cloth into 20 L toluene solution that contains 10 mM vinyltrimethoxysilane, hold for 10 h, and then take out the wool cloth and dry for 2 h at 80° C.;

(2) Immerse the rabbit wool cloth treated by step (1) in mixed solution of water and methanol (at a volume ratio of 2:1) with pH=13 adjusted by ammonia, at a bath ratio of 1:10, and agitate for 10 min at room temperature; then, add water solution of sodium silicate at a concentration of 1 mol/L, and control the mass fraction of sodium silicate in the mixed solution of water and methanol with pH=13 at 5%, and agitate for 2 min at a constant temperature of 100° C.; adjust the pH value of the reacting solution with nitric acid to 4, and then oscillate for 100 min at a constant temperature of 80° C.;

(3) Take out the rabbit wool cloth treated by step (2), rinse it with tap water for three times, and dry it, to obtain a superhydrophilic rabbit wool cloth with wash fastness.

The result of static contact angle test indicates that the contact angle between the surface of rabbit wool cloth and water is zero. The result of SEM analysis indicates that the fiber surface of the treated rabbit wool cloth has a layer of nanometer silicon dioxide with a particle diameter of about 80 nm obtained from hydrolization of sodium silicate and grafted to the fiber surface by chemical bonds. 1000.5 g rabbit wool cloth grafted with nanometer silicon dioxide is obtained. Based on the total mass of the rabbit wool cloth, the content of silicon dioxide is about 0.05% by mass.

### Example 8

(1) Rinse and dry the blended wool and cashmere cloth (at a mass ratio of 7:3) to be treated, and weigh 200 g cloth, immerse the cloth into 5 L ethanol solution that contains 10 mM methyltrimethoxysilane and 10 mM isopropyl tri(dioctyl pyrophosphate) titanate, hold for 3 h, and then take out the cloth and dry for 1 h at 80° C.;

(2) Immerse the blended wool and cashmere cloth treated by step (1) in water with pH adjusted to 14 by lithium hydroxide, at a bath ratio of 1:60; agitate for 15 min at room temperature; then, add ethanol solution of tetramethyl orthosilicate at a concentration of 3 mol/L and ethanol solution of tetraethyl orthosilicate at a concentration of 2 mol/L in sequence, and control the mass fraction of tetramethyl orthosilicate and mass fraction of tetraethyl orthosilicate in the water solution with pH=14 at 5% respectively, and agitate for 300 min at a constant temperature of 30° C.; adjust the pH value of the reacting solution with oxalic acid to 3, and then oscillate for 80 min at a constant temperature of 70° C.;

(3) Take out the blended wool and cashmere cloth treated by step (2), rinse it with tap water for three times, and dry it, to obtain a superhydrophilic blended wool and cashmere cloth with wash fastness.

The result of static contact angle test indicates that the contact angle between the surface of blended wool and cashmere cloth and water is zero. The result of SEM analysis indicates that the fiber surface of the treated blended wool and cashmere cloth has a layer of nanometer silicon dioxide with a particle diameter of about 150 nm obtained from hydrolization of tetramethyl orthosilicate and tetraethyl orthosilicate and grafted to the fiber surface by chemical bonds. 208 g blended wool and cashmere cloth grafted with nanometer silicon dioxide is obtained. Based on the total mass of the blended wool and cashmere cloth, the content of silicon dioxide is about 3.8% by mass.

### Example 9

(1) Rinse and dry the sheep wool cloth to be treated, weigh 100 g cloth, and immerse it into 1 L ethanol solution that contains 10 mM tetra-(2,2-diallyloxy-methyl-1-butyl) bis[di(tridecyl) phosphate] titanate, hold for 200 min, and then take out the cloth and dry for 30 min naturally;

(2) Immerse the sheep wool cloth treated by step (1) in mixed solution of methanol and ethanol (at a volume ratio of 1:1) with pH=12 adjusted by ammonia, at a bath ratio of 1:60, and agitate for 25 min at room temperature; then, add water solution of sodium silicate at a concentration of 1 mol/L, and control the mass fraction of sodium silicate in the mixed solution of methanol and ethanol with pH=12 at 10%, and agitate for 300 min at a constant temperature of 40° C.; adjust the pH value of the reacting solution with hydrochloric acid to 1, and then oscillate for 80 min at a constant temperature of 80° C.;

(3) Take out the wool cloth treated by step (2), rinse it with tap water for three times, and dry it, to obtain a superhydrophilic wool cloth with wash fastness.

The result of static contact angle test indicates that the contact angle between the surface of sheep wool cloth and water is zero. The result of SEM analysis indicates that the fiber surface of the treated sheep wool cloth has a layer of nanometer silicon dioxide with a particle diameter of about 400 nm obtained from hydrolization of sodium silicate and grafted to the fiber surface by chemical bonds. 100.6 g sheep wool cloth grafted with nanometer silicon dioxide is obtained. Based on the total mass of the sheep wool cloth, the content of silicon dioxide is about 0.6% by mass.

### Example 10

(1) Rinse and dry the sheep wool cloth to be treated, and weigh 200 g sheep wool cloth, immerse the wool cloth into 2 L toluene solution that contains 50 mM N-methyl-γ-aminopropyl trimethoxysilane and 50 mM N-methyl-γ-aminopropyl triethoxysilane, hold for 2 h, and then take out the sheep wool cloth and dry for 10 h naturally;

(2) Immerse the sheep wool cloth treated by step (1) in a mixed solution of water and dimethyl sulfoxide (mixed at a volume ratio of 5:1) with pH adjusted to 11 by sodium hydroxide, at a bath ratio of 1:40; agitate for 30 min at room temperature; then, add methanol solution of tetramethyl orthosilicate at a concentration of 5 mol/L and zinc acetate powder in sequence, and control the mass fraction of tetramethyl orthosilicate in the mixed solution of water and dimethyl sulfoxide with pH=11 at 5% and the mass fraction of zinc acetate in the mixed solution of water and dimethyl sulfoxide at 10%, and agitate for 300 min at a constant temperature of 60° C.; adjust the pH value of the reacting solution with acetic acid to 3, and then oscillate for 20 min at a constant temperature of 100° C.;

(3) Take out the sheep wool cloth treated by step (2), rinse it with tap water for three times, and dry it, to obtain a multi-functional superhydrophilic wool cloth with wash fastness.

The result of static contact angle test indicates that the contact angle between the fiber surface of sheep wool cloth and water is zero. The result of SEM analysis indicates that the fiber surface of the treated sheep wool cloth has a particle layer composed of nanometer silicon dioxide with a particle diameter of about 200 nm obtained from hydrolization of tetramethyl orthosilicate and nanometer zinc oxide particles with a particle diameter of 30-50 nm obtained from hydrolization of zinc acetate, and grafted by chemical bonds. 214 g wool cloth grafted with nanometer silicon dioxide is obtained; the mass ratio between silicon and zinc obtained by X-ray energy spectrum test is 0.23:1. Based on the total mass of the sheep wool cloth, the content of nanometer silicon dioxide particles is about 1.2% by mass, and the content of the nanometer zinc oxide particles is about 5% by mass.

### Example 11

(1) Rinse and dry the sheep wool cloth to be treated, and weigh 100 g sheep wool cloth, immerse the wool cloth into 2 L toluene solution that contains 50 mM N-methyl-γ-aminopropyl trimethoxysilane and 50 mM N-methyl-γ-aminopropyl triethoxysilane, hold for 2 h, and then take out the wool cloth and dry for 10 h naturally;

(2) Add silicon dioxide particles with a particle diameter of 50 nm into water at a mass fraction of 1%, agitate for 5 min, and immerse the sheep wool fabric treated by step (1) into the reacting solvent, at a bath ratio of 1:50; adjust the pH value of the reacting solution to 3 with hydrochloric acid, and then oscillate for 20 min at a constant temperature of 80° C.;

(3) Take out the sheep wool cloth treated by step (2), rinse it with tap water for three times, and dry it, to obtain a superhydrophilic wool cloth with wash fastness.

The result of static contact angle test indicates that the contact angle between the surface of wool cloth and water is zero. The result of SEM analysis indicates that the fiber surface of the treated sheep wool cloth has a layer of nanometer silicon dioxide with a particle diameter of 50 nm grafted by chemical bonds. 100.1 g sheep wool cloth grafted with nanometer silicon dioxide is obtained. Based on the total mass of the sheep wool cloth, the content of silicon dioxide is about 0.1% by mass.

### Example 12

(1) Rinse and dry the sheep wool cloth to be treated, and weigh 100 g sheep wool cloth, immerse the sheep wool cloth into 2 L ethanol solution that contains 20 mM bis[3-(triethoxysilyl) propyl] amine, hold for 1 h, and then take out the sheep wool cloth and dry for 20 min at 80° C.;

(2) Add silicon dioxide particles with a particle diameter of 50 nm and nanometer titanium oxide particles with a particle diameter of 30 nm into water, and control the mass fraction of silicon dioxide particles in water at 1% and the mass fraction of nanometer titanium oxide particles in water at 1%; agitate for 10 min, and immerse the wool fabric treated by step (1) into the reacting solvent, at a bath ratio of 1:10; adjust the pH value of the reacting solution to 4 with acetic acid, and then oscillate for 20 min at a constant temperature of 100° C.;

(3) Take out the sheep wool cloth treated by step (2), rinse it with tap water for three times, and dry it, to obtain a multi-functional superhydrophilic wool cloth with wash fastness.

The result of static contact angle test indicates that the contact angle between the surface of sheep wool cloth and water is zero. The result of SEM analysis indicates that the fiber surface of the treated sheep wool cloth has a particle layer composed of nanometer silicon dioxide with a particle diameter of 50 nm and nanometer titanium oxide with a particle diameter of 30 nm, and grafted by chemical bonds. 103.4 g sheep wool cloth grafted with nanometer silicon dioxide is obtained; the mass ratio between silicon and titanium obtained in X-ray energy spectrum test is 1.43:1. Based on the total mass of the sheep wool cloth, the content of nanometer silicon dioxide is about 2% by mass, and the content of the nanometer titanium oxide is about 1.4% by mass.

1. A superhydrophilic wool fabric with wash fastness, comprising nanometer particles grafted by chemical bonds on the surface of wool fiber; the nanometer particles comprise nanometer silicon dioxide with a particle diameter of 10-800 nm; based on the total mass of the wool fabric, the content of the nanometer silicon dioxide is 0.05-5% by mass.

2. The superhydrophilic wool fabric with wash fastness according to claim 1, wherein, the nanometer particles further comprise functional nanometer particles being at least one selected from the group consisting of nanometer gold with a particle diameter of 1-100 nm, nanometer silver with a particle diameter of 1-100 nm, nanometer copper with a particle diameter of 1-100 nm, nanometer titanium oxide with a particle diameter of 5-500 nm, and nanometer zinc oxide with a particle diameter of 5-500 nm; based on the total mass of the wool fabric, the content of the functional nanometer particles is 0.05-5% by mass.

3. A nano-finishing method for producing the superhydrophilic wool fabric with wash fastness as described in claim 1, comprising:
(1) rinsing and drying the wool fabric to be treated, immersing the wool fabric into a solution that contains coupling agent at a concentration of 2-2000 mmol/L and keeping for 2 min-10 h, taking out the wool fabric, and drying it naturally or at 40-100° C.;
(2) adding silicon dioxide particles with a particle diameter of 10-800 nm into a reacting solvent to make the mass fraction of the silicon dioxide particles in the reacting solvent be 0.1-10%, immersing the wool fabric treated by step (1) into the reacting solvent and keeping the bath ratio at 1:5-1:100, adjusting the pH value of the reacting solution to 1-7 by an acid, and then oscillating at a constant temperature within a range of 40-100° C.; or
adjusting the pH value of a reacting solvent with an inorganic base to 8-14, immersing the wool fabric treated by step (1) into the reacting solvent and keeping the bath ratio at 1:5-1:100; agitating; adding a solution that contains a precursor of silicon dioxide and controlling the content of the precursor of silicon dioxide in the reacting solvent at a mass fraction of 0.1-10%, and agitating at a constant temperature within a range of 30-100° C.; adjusting the pH value of the reacting solution to 1-7 by an acid, and then oscillating at a constant temperature within a range of 40-100° C.;
(3) taking out the wool fabric treated by step (2), and rinsing and drying it, to obtain the superhydrophilic wool fabric with wash fastness;
the reacting solvent is at least one selected from the group consisting of water, methanol, ethanol, propanol, butanol, toluene, tetrachloroethylene, methylene chloride, N,N-dimethyl formamide and dimethyl sulfoxide.

4. The method according to claim 3, further comprising the following steps:
adding functional nanometer particles, before or after adding silicon dioxide particles with a particle diameter of 10-800 nm and before adjusting the pH value of the reacting solution with an acid to 1-7 and before oscillating at a constant temperature within a range of 40-100° C.; or
adding functional nanometer particles to the reacting solvent, before adding the solution that contains the precursor of silicon dioxide, or after adding the solution that contains the precursor of silicon dioxide and before agitating at a constant temperature within a range of 30-100° C.;
wherein, the functional nanometer particles is at least one selected from the group consisting of nanometer gold with a particle diameter of 1-100 nm, nanometer silver with a particle diameter of 1-100 nm, nanometer copper with a particle diameter of 1-100 nm, nanometer titanium oxide with a particle diameter of 5-500 nm, and nanometer zinc oxide with a particle diameter of 5-500 nm, and the mass fraction of the functional nanometer particles in the reacting solvent is 0.1-10%.

5. The method according to claim 3, wherein, the solvent used for preparing the solution that contains coupling agent is at least one selected from the group consisting of methanol, ethanol, propanol, butanol, amyl alcohol, toluene, tetrachloroethylene, methylene chloride, N,N-dimethyl formamide and dimethyl sulfoxide;
the coupling agent is at least one selected from the group consisting of silane coupling agent with epoxy group, silane coupling agent with amino group, silane coupling agent with vinyl group, silane coupling agent with alkyl group, and coupling agent based on titanate.

6. The method according to claim 5, wherein, the silane coupling agent with epoxy group is γ-glycidoxypropyltrimethoxysilane, γ-glycidoxypropyltriethoxysilicane, or their mixture;
the silane coupling agent with amino group is at least one selected from the group consisting of γ-aminopropyl trimethoxysilane, γ-aminopropyl triethoxysilane, bis[3-(triethoxysilyl) propyl] amine, γ-aminopropyl methyl dimethoxysilane, N-methyl-γ-aminopropyl trimethoxysilane, and N-methyl-γ-aminopropyl triethoxysilane.
the silane coupling agent with vinyl group is at least one selected from the group consisting of vinyltrimethoxysilane, vinylmethyldimethoxysilane, vinyltriethoxysilane, and vinylmethyldiethoxysilane.
the silane coupling agent with alkyl group is at least one selected from the group consisting of methyltrimethoxysilane, methyltriethoxysilane, propyltrimethoxysilane, and propyltriethoxysilicane.
the coupling agent based on titanate is at least one selected from the group consisting of isopropyl triisophthaloyl titanate, isopropyl dodecylbenzenesulfonyl titanate, isopropyl tri(dioctyl pyrophosphate) titanate, tetraisopropyl bis(dioctyl phosphite) titanate, tetraoctyl bis[di(dodecyl) phosphite] titanate, tetra(2,2-diallyloxy-methyl-1-butyl) bis[(di(tridecyl) phosphate] titanate, bis(dioctyl pyrophospate)oxyacetate titanate, and bis(dioctyl pyrophosphate)ethylene titanate.

7. The method according to claim 3, wherein, the amount of the solution that contains coupling agent is 5-50 L per 1 kg wool fabric.

8. The method according to claim 3, wherein, the precursor of silicon dioxide is at least one selected from the group consisting of sodium silicate, tetramethyl orthosilicate, tetraethyl orthosilicate, tetrapropyl orthosilicate, and tetrabutyl orthosilicate.

9. The method according to claim 3, wherein , the inorganic base is at least one selected from the group consisting of lithium hydroxide, sodium hydroxide, potassium hydroxide, and ammonia;
the acid is at least one selected from the group consisting of hydrochloric acid, formic acid, oxalic acid, acetic acid, nitric acid, phosphoric acid, and sulfuric acid.

10. The method according to claim 3, wherein, the time of natural drying described in step (1) is 30 min-10 h; the time of drying performed at a temperature of 40-100° C. is 5-300 min.

11. The method according to claim 3, wherein, the time of agitation performed at a constant temperature within the range of 30-100° C. described in step (2) is 2-300 min.; the time of oscillation performed at a constant temperature within a range of 40-100° C. is 20-200 min.

12. The method according to claim 5, wherein, the amount of the solution that contains coupling agent is 5-50 L per 1 kg wool fabric.

13. The method according to claim 4, wherein, the precursor of silicon dioxide is at least one selected from the group consisting of sodium silicate, tetramethyl orthosilicate, tetraethyl orthosilicate, tetrapropyl orthosilicate, and tetrabutyl orthosilicate.

14. The method according to claim 4, wherein, the acid is at least one selected from the group consisting of hydrochloric acid, formic acid, oxalic acid, acetic acid, nitric acid, phosphoric acid, and sulfuric acid.

15. The method according to claim 4, wherein, the time of agitation performed at a constant temperature within the range of 30-100° C. described in step (2) is 2-300 min.; the time of oscillation performed at a constant temperature within a range of 40-100° C. is 20-200 min
